(19) United States
(12) Patent Application Publication
(10) Pub. No.: US 2002/0116611 A1
(43) Pub. Date: Aug. 22, 2002

(54) Secure distributed on-line certification authority

(75) Inventors: Lidong Zhou, Ithaca, NY (US); Fred B. Schneider, Ithaca, NY (US); Robbert VanRenesse, Ithaca, NY (US); Zygmunt Haas, Millburn, NJ (US)

Correspondence Address: PERKINS, SMITH & COHEN LLP, ONE BEACON STREET, 30TH FLOOR, BOSTON, MA, 02108, US

(73) Assignee: Cornell Research Foundation, Inc.

(21) Appl. No.: 10/001,588

(22) Filed: Oct. 31, 2001

Related U.S. Application Data
(60) Provisional application No. 60/244,461, filed on Oct. 31, 2000.

(51) Int. Cl. H04L 9/32

(52) U.S. Cl. 713/156; 713/176; 713/201

(57) ABSTRACT

A fault-tolerant and secure on-line certification authority uses replication to achieve availability. A client request is forwarded to a delegate server. The delegate forwards the request to all certification servers. After receiving responses from a quorum of certification servers, the delegate sends a client response including a threshold signature protocol to sign the client response. The delegate then forwards the client response to the client.

### CROSS REFERENCE TO RELATED APPLICATIONS

This application claims priority of U.S. Provisional Application Serial No. 60/244,461 filed Oct. 31, 2000 which is incorporated herein by reference.

### STATEMENT OF GOVERNMENT INTEREST

This invention was made partially with U.S. Government support from ARPA/RADC grant F30602-96-1-0317, AFOSR grant F49620-00-1-0198, Defense Advanced Research Projects Agency (DARPA) and Air Force Research Laboratory Air Force Material Command USAF under agreement number F30602-99-1-0533, and National Science Foundation Grant 9703470. The U.S. Government has certain rights in the invention.

### BACKGROUND OF THE INVENTION

This invention relates generally to implementing fault-tolerant and secure services in networked computer systems, and, more particularly to a fault tolerant and secure on-line certification authority.

In a public key infrastructure, a certificate specifies a binding between a name and a public key or other attributes. Over time, public keys and attributes might change-a private key might be compromised, leading to selection of a new public key, for example. The old binding and the certificate that specifies that binding then become invalid. A certification authority (CA) attests to the validity of bindings in certificates by digitally signing the certificates it issues and by providing a means for clients to check the validity of certificates. With an on-line CA, principals can check the validity of certificates just before using them. This reduces the vulnerability caused by any gap between when a CA is notified that a binding has become invalid and when a CA's clients learn that the corresponding certificates are invalid.

Among the vulnerabilities of a CA system are denial of service attacks and mobile adversary attacks. Denial of service attacks are repeated requests by an attacker for one operation that effectively blocks other requests for services. A large class of successful denial of service attacks work by exploiting an imbalance between the resources an attacker must expend to submit a request and the resources the service must expend to satisfy that request. If making a request is cheap but processing one is not, then attackers have a cost-effective way to disrupt a service by submitting bogus requests to saturate server resources. Many denial of service attacks succeed by invalidating stronger communication and execution-timing assumptions.

Ω is an on-line CA that uses replication and threshold cryptography as described in M. K. Reiter, et al., “The Ω Key Management Service,” Journal of Computer Security, 4(4), pp. 267-297, 1996. Ω, however, was not intended to resist denial of service attacks or mobile adversaries. In fact, a vulnerability to denial of service attacks seems to be inherent in its design. Ω implements process groups in an asynchronous distributed system where compromised processors can exhibit arbitrary behavior. Groups of replicas are managed and non-responsive members are removed from the process groups to ensure the system does not stall due compromised replicas. It is impossible, however, to distinguish between slow and halted processors in an asynchronous system, so timeouts are used to identify processors that might be compromised. A correct, but slow, server might thus be removed from a process group, and that constitutes a denial of service vulnerability. In addition, an adversary can launch denial of service attaches by instigating membership changes because making group membership changes involves expensive protocols. Ω also has no defense against mobile adversaries.

Another system is the Byzantine Fault Tolerant (BFT) system described in M. Castro and B. Liskov, “Practical Byzantine Fault Tolerance,” Proceedings of the 3rd USENIX Symposium on Operating System Design and Implementation, 1999, pp. 173-186. The BFT system tolerates arbitrary failures in an asynchronous system but was not designed for denial of service attacks. The BFT architectures uses expensive view-change protocols that preclude an easy defense against denial of service attacks.

The Phalanx system uses a masking Byzantine quorum system that tolerates few compromised servers as described in D. Malkhi and M. Reiter, “Byzantine Quorum Systems,” Distributed Computing, 11(4), pp. 203-213, 1998. Phalanx clients communicate directly with the Phalanx servers. This architecture means that Phalanx clients are not isolated from, for example, changes to individual server keys. Thus, Phalanx is not suitable for use in settings where scaling to large numbers of clients is important.

The IBM Corp. e-vault repository implements Rabin's information dispersal algorithm for storing and retrieving files. Information is stored in e-vault with optimal space efficiency. The e-vault protocols, however, assume a synchronous model of computation and thus, involve strong assumptions about execution timing and delivery delays. Strong assumptions constitute a denial of service vulnerability. That is, an attacker having the ability to overload processors or clog the network can invalidate the assumptions and cause protocols to fail.

It is therefore an object of this invention to provide a method and apparatus for a secure, fault-tolerant on-line certification authority.

### SUMMARY OF THE INVENTION

The objects set forth above as well as further and other objects and advantages of the present invention are achieved by the embodiments of the invention described hereinbelow.

This invention provides a fault-tolerant and secure on-line certification authority that has applicability both in a local area network and in wide area networks like the Internet. Replication is used to achieve availability. Proactive recovery with threshold cryptography is used for digitally signing certificates in a way that defends against mobile adversaries which attack, compromise, and control one replica for a limited period of time before moving on to another. Relatively weak assumptions characterize environments in which the protocols will execute correctly. No assumption is made about execution speed and message delivery delays; channels are expected to exhibit only intermittent reliability; and with 3t+1 servers up to t may be faulty or compromised. The result is a system with inherent defenses to certain denial of service attacks because, by their very nature, weak assumptions are difficult for attackers to invalidate.

In addition, traditional techniques, including request authorization, resource management based on segregation and scheduling different classes of requests, as well as caching results of expensive cryptographic operations further reduce vulnerability to denial of service attacks of the on-line certification authority of this invention.

The present invention has the advantage of providing an on-line certification authority thereby reducing risks associated with a gap between the time a certificate becomes invalid and the time a client using that certificate becomes aware of the invalidation.

The present invention has an advantage of providing mechanisms for defense against both denial of service attacks and mobile adversary attacks.

The present invention has an advantage of transparency thereby shielding clients from, for example, servers refreshing their public/private key pairs.

The present invention has a still further advantage of combining threshold cryptography with proactive secret sharing in a manner that uses a weak system model further incorporating a defense against denial of service attacks.

Finally, the present invention has an advantage of making no assumptions about timing, thereby reducing vulnerability related to denial of service attacks, e.g., attacks that overload processors or obstruct networks to invalidate a given synchrony assumption.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a schematic representation of client request processing with the present invention;

FIG. 2 is a flow chart of the client process of the present invention; and

FIG. 3 is a flow chart of the server process of the present invention.

### DETAILED DESCRIPTION OF THE PREFERRED EMBODIMENTS

The present on-line certification authority is implemented by a set of servers, each running on a separate processor in a network. It is intended, but not limited, to using the invention in an environment like the Internet. Thus, the on-line CA must tolerate failures and defend against malicious attacks that target clients, servers, and network communications links, as follows:

Servers: On-line CA servers are either correct or compromised, where a compromised server might stop executing, deviate arbitrarily from its specified protocols (i.e., Byzantine failure), and/or might disclose information stored locally. System execution comprises a sequence of protocol-defined windows of vulnerability. The terms “correct” and “compromised” refer to those periods. Specifically, a server is deemed correct in a window of vulnerability if and only if that server is not compromised throughout that period. It is assumed that,

at most, t of the n on-line CA servers are ever compromised during each protocol-defined window of vulnerability, where 3t+1≦n holds. Further, it is assumed that clients and on-line CA servers can digitally sign messages using some scheme that is non-existentially forgeable, even with adaptive chosen message attacks. It is also assumed that various cryptographic schemes (e.g., public key cryptography and threshold cryptography) that this invention employs are secure.

Fair Links: A fair communication link does not necessarily deliver all messages sent, but if a process using such a link sends infinitely many messages to a single destination then infinitely many of those messages are correctly delivered. Without some comparable assumption about the network, an adversary could prevent on-line CA servers from communicating with each other or with clients.

Asynchrony: There is no bound on message delivery delay or server execution speed. Assumptions about those bounds could be invalidated by denial of service attacks. By eschewing such assumptions, a class of vulnerabilities is thus eliminated.

These three classes of assumptions endow adversaries with considerable power. Attackers can attack on-line CA servers, provided fewer than ⅓ of the on-line CA servers are compromised within a given interval; launch eavesdropping, message insertion, corruption, deletion, reordering, and replay attacks, provided Fair Links is not violated; and conduct denial of service attacks that delay messages or slow on-line CA servers by arbitrary finite amounts.

The on-line certification authority of the present invention supports one operation (Update) to create, update, and invalidate bindings; and a second operation (Query) to retrieve certificates specifying those bindings. A client invokes an operation by issuing a request and then awaiting a response. The on-line CA expects each request to contain a nonce. In the current implementation, requests contain sequence numbers which, along with the client's name, form unique numbers. Therefore, the text of the request itself can serve as the nonce. Responses from the on-line CA are digitally signed with a service key forming part of the invention and include the client's request, hence the nonce, thereby enabling a client to check whether a given response was produced by the on-line CA for that client's request.

A request is considered accepted by the on-line certification authority once any correct on-line CA server receives the request or participates in processing the request; and a request is considered completed once some correct server has constructed the response. It might, at first, seem more natural to deem a request “completed” once the client receives a response, but such a definition would make a client action (receipt of a response) necessary for a request to be considered completed.

Request Completion: Every request accepted is eventually completed. Guarantee then becomes problematic in the absence of assumptions about clients. A correct client that makes a request, however, will eventually receive a response from the on-line certification authority.

Certificates stored by the on-line CA are X.509 compliant. It will be convenient here to regard each certificate ζ simply as a digitally signed attestation that specifies a binding between some name cid and some public key or other attributes pubK. In addition, each certificate ζ contains a unique serial number σ (ζ) assigned by the present system. The following semantics of the on-line CA's Update and Query operations give meaning to the natural ordering on the certificate serial numbers-namely, that a certificate for cid invalidates certificates for cid having lower serial numbers.

In the Update operation, given a certificate ζ for a name cid and given a new binding pubK′ for cid, an Update request returns an acknowledgment after the on-line CA has created a new certificate ζ′ for cid such that ζ′ binds pubK′ to cid and σ(ζ)<σ(ζ′) holds.

In the Query operation, given a name cid, a Query request Q returns a certificate ζ for cid such that: (i) ζ was created by some Update request that was accepted before Q completed; (ii) for any certificate ζ′ for name cid created by an Update request that completed before Q was accepted, σ(ζ′)<σ(ζ) holds.

By assuming an initial default binding for every possible name, the operation to create a first binding for a given name can be implemented by Query (to retrieve the certificate for the default binding) followed by Update. An operation to revoke a certificate for cid is easily built from Update by specifying a new binding for cid.

Update creates and invalidates certificates, so it should probably be restricted to certain clients. Consequently, this invention allows an authorization policy to be defined for Update. In principle, a CA could always process a Query, because Query does not affect any binding. In practice, that policy would create a vulnerability to denial of service attacks, so this invention adopts a more conservative approach, as discussed below.

The semantics of Update associates larger serial numbers with newer certificates and, in the absence of concurrent execution, a Query for cid returns the certificate whose serial number is the largest of all certificates for cid.

Certificate serial numbers are actually consistent only with a service-centric causality relation: the transitive closure of relation →, where ζ→ζ′ holds if and only if ζ′ is created by an Update having ζ as input. Two Update requests U and U′ submitted, for example, by the same client, serially, and where both input the same certificate, are not ordered by the → relation. Thus, the semantics of Update allows U to create a certificate ζ′, U′ to create a certificate ζ′, and σ(ζ′)<σ(ζ) to hold. This is consistent with the service-centric causality relation but the opposite of what is required for serial numbers consistent with Lamport's more-useful potential causality relation (because execution of U is potentially causal for execution of U′).

The on-line CA is forced to employ the service-centric causality relation because it has no way to obtain information it can trust about causality involving operations it does not itself implement. Clients would have to provide the on-line CA with that information, and compromised clients might provide bogus information. By using service-centric causality, the on-line CA and its clients are not hostage to information about causality furnished by compromised clients.

Update and Query are not indivisible and (as will become apparent later) are not easily made so: the on-line CA's Update involves separate actions for the invalidation and for the creation of certificates. In implementing Update, either possible ordering for these actions are contemplated: Execute invalidation first, and there is a period when no certificate is valid; or execute invalidation last, and there is a period when multiple certificates are valid.

Since Query is wanted to return a certificate, having periods with no valid certificate for a given name would have meant synchronizing Query with concurrent Update requests. This is rejected because the synchronization creates an execution-time cost and introduces a vulnerability to denial of service attacks; specifically, repeated requests by an attacker for one operation could now block requests for another operation. The solution is to have Update create the new certificate before invalidating the old one, but it, too, is not without unpleasant consequences. Both of the following cannot now hold:

(i) A certificate for cid is valid if and only if it is the certificate for cid with largest serial number.

(ii) Query always returns a valid certificate.

The on-line CA's clients therefore live with a semantics for Query that is more complicated than one might have hoped for.

The on-line CA of this invention is designed to operate provided no more than t on-line CA servers are compromised within a protocol-defined window of vulnerability. The duration of this window of vulnerability cannot be characterized in terms of real time due to the Asynchrony assumption, so its duration is defined in terms of events marking the completion of protocols (described below) that are executed periodically to refresh keys and on-line CA server states. Together, these proactive recovery protocols reconstitute the state of each on-line CA server (which might have been corrupted during the previous window of vulnerability) and obsolete keys an attacker might have obtained by compromising on-line CA servers.

Each window of vulnerability at the on-line CA server begins when that on-line CA server starts executing the proactive recovery protocols and terminates when that on-line CA server has again started and finished those protocols. Thus, every execution of the proactive recovery protocols is part of two successive windows of vulnerability. The on-line CA is agnostic about when the proactive recovery protocols start. Currently, each on-line CA server attempts to run these protocols after a specified interval has elapsed on its local clock but (to avoid denial of service attacks) an on-line CA server will refuse to participate in the protocols unless enough time has passed on its clock since they last executed.

In theory, using protocol events to delimit the window of vulnerability affords attackers leverage. Denial of service attacks that slow on-line CA servers and/or increase message delivery delays expand the real-time duration for the window of vulnerability, creating a longer period during which attackers can try to compromise more than t on-line CA servers. In practice, assumptions about timing can be made for those portions of the system that have not been compromised. For example, an on-line CA server that violates these stronger execution timing assumptions might be considered compromised. Given such information about on-line CA server execution speeds and message-delivery delays, real-time bounds on the window of vulnerability can be computed.

Approaches to limiting the utility of compromised keys are now described.

Server Keys. Each on-line CA server maintains a private/public key pair, with the public key given to all on-line CA servers. These public keys allow on-line CA servers to authenticate the senders of messages they exchange with other on-line CA servers.

Public keys of the on-line CA servers are not given to the clients so that clients need not be informed of changed on-line CA server keys-attractive in a system with a large number of clients and where a proactive recovery protocol periodically refreshes on-line CA server keys. Without knowledge of on-line CA server keys, however, clients cannot easily determine the on-line CA server that sent a message. This, in turn, precludes voting or other schemes in which a client synthesizes or counts responses from individual on-line CA servers to obtain the CA's response.

Service Key. There is one service private/public key pair. It is used for signing responses and certificates. All clients and on-line CA servers know the service public key.

The service private key is held by no single on-line CA server. Instead, different shares of the key are stored on each of the on-line CA servers, and threshold cryptography is used to construct signatures on responses and certificates. To sign a message, (i) each on-line CA server generates a partial signature from the message and that on-line CA server's share of the service private key; (ii) one of the on-line CA servers combines these partial signatures and obtains the signed message.

One might think partial signatures could be combined by clients (instead of on-line CA servers) to obtain a signed message, but that introduces a vulnerability to denial of service attacks. Lacking the on-line CA server public keys, clients do not have a way to authenticate the origins of messages conveying the partial signatures. Therefore, a client could be bombarded with bogus partial signatures, and only by actually trying to combine these fragments-an expensive enterprise-could the bona fide partial signatures be identified.

With (n, t+1) threshold cryptography, t+1 or more partial signatures are needed in order to generate a signature. An adversary must therefore compromise t+1 on-line CA servers in order to forge on-line CA signatures.

Proactive Recovery. A mobile adversary might compromise t+1 on-line CA servers over a period of time and, in so doing, collect the t+1 shares of the service private key. Consequently, the on-line CA employs a proactive secret sharing protocol to refresh these shares, periodically generating a new set of shares for the service private key. New shares cannot be combined with old shares to construct signatures. Periodic execution of this proactive secret sharing protocol, also called proactive recovery, ensures that a mobile adversary can forge the on-line CA signatures only by compromising t+1 on-line CA servers in the interval between protocol executions. The proactive secret sharing protocol that the on-line CA employs makes no synchrony assumptions unlike prior work. The present invention regards the protocols simply as services that the on-line CA invokes.

To satisfy Request Completion discussed above, an accepted request that has not been completed when a window of vulnerability ends must become an accepted request in the next window of vulnerability. Therefore, correct on-line CA servers about to execute the proactive recovery protocol resubmit to all on-line CA servers any requests that are then in progress. These requests are marked so that they will be processed during the correct (i.e., next) window of vulnerability. Some on-line CA server that is correct in this next window of vulnerability will receive the request. Thus, by definition, in-progress accepted requests in the previous window of vulnerability remain accepted in the next one.

In practice, windows of vulnerability tend to be long (viz. days) relative to the time (5 seconds or less) required for processing a Query or Update request. It is thus extremely unlikely that a request restarted in a subsequent window of vulnerability would not be completed before proactive recovery is again commenced.

In addition to generating new on-line CA server keys and new shares of the service key, the on-line CA also periodically refreshes the states of its servers. This is done as part of proactive recovery. The state of an on-line CA server comprises a set of certificates. In theory, this state could be refreshed by performing a Query request for each name that could appear in a certificate. The cost of that becomes prohibitive when many certificates are being stored by the on-line CA. So instead, during proactive recovery, a list with the name and serial number for every valid certificate stored by each on-line CA server is sent to every other. Upon receiving this list, an on-line CA server retrieves any certificates that appear to be missing. Certificates stored by the on-line CA servers are signed by the on-line CA. A certificate retrieved from another on-line CA server can thus be checked to make sure it is not bogus. The certificate serial numbers enable on-line CA servers to determine which of their certificates have been invalidated (because a certificate for that same name but with a higher serial number exists).

In the on-line CA of the present invention, every client request is processed by multiple on-line CA servers and every certificate is replicated on multiple on-line CA servers. The replication is managed as a dissemination Byzantine quorum system, which is feasible because it is assumed that 3t+1<n holds. So on-line CA servers are organized into sets, called Quorums (Provided there are 3t+1 on-line CA servers and at most t of those on-line CA servers may be compromised, the quorum system {Q: |Q|=2t+1} constitutes a dissemination Byzantine quorum system. For simplicity, it is assumed that n=3t+1 holds; the protocols are easily extended to cases where n>3t+1 holds.), satisfying:

Quorum Intersection: The intersection of any two quorums contains at least one correct server.

Quorum Availability: A quorum comprising only correct servers always exists.

Every client request is processed by all correct on-line CA servers in some quorum. Detailed protocols for Query and Update appear as an Appendix. There are certain technical challenges that occur.

First, different correct on-line CA servers might process different Update requests because requests are processed by a quorum of on-line CA servers but not necessarily by all correct on-line CA servers. Consequently, different certificates for a given name cid are stored by correct on-line CA servers. Certificate serial numbers provide a solution to the problem of determining which of those is the correct certificate. Second, a client making a request cannot authenticate messages from a on-line CA server because clients do not know the on-line CA server public keys. Therefore, a client cannot determine whether a quorum of on-line CA servers has processed that request. The solution is for some of the on-line CA servers to become delegates for each request. A delegate presides over the processing of a client request and, being an on-line CA server, can authenticate on-line CA server messages and assemble the needed partial signatures from other on-line CA servers. A client request is handled by t+1 delegates to ensure that at least one of these delegates is correct. Finally, retransmission of messages may be necessary because communication is done using fair links.

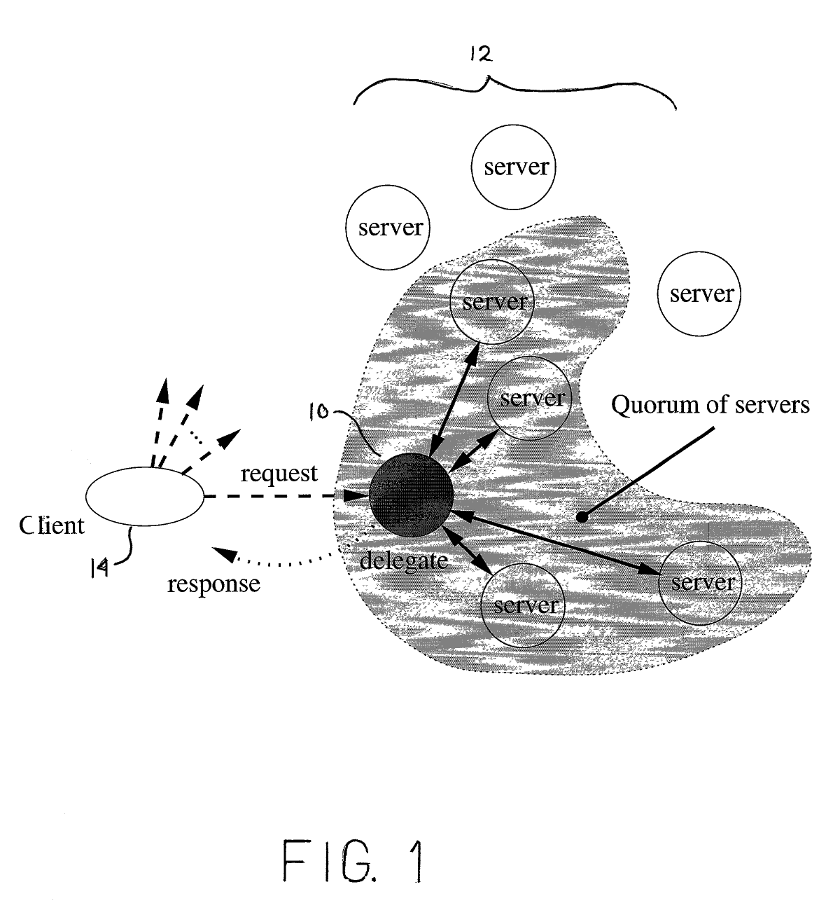

FIG. 1 summarizes this high-level view of how the present on-line CA operates by depicting one of the t+1 delegates 10 and the quorum of on-line CA servers 12 working with that delegate to handle a client 14 request.

The protocol details are as follows:

Certificate Serial Numbers. The serial number σ(ζ) for an on-line CA certificate ζ is a pair <υ(ζ), h(R_{ζ})>, where υ(ζ) is a version number and h(R_{ζ}) is a collision-resistant hash of the Update request R_{ζ} that led to creation of ζ. Version numbers encode the service-centric causality relation as follows:

The first certificate created to specify a binding for a name cid is assigned version number 0.

A certificate ζ′ produced by an Update given certificate ζ is assigned version number υ(ζ′)=υ(ζ)+1.

Certificates created by different requests have different serial numbers because different requests have different collision-resistant hashes. The usual lexicographic ordering on serial numbers yields the total ordering on serial numbers sought—an ordering consistent with the transitive closure of the → relation.

Note that even with serial numbers on certificates, the same new certificate will be created by an on-line CA server if an Update request is re-submitted. This is because the serial number of a certificate is entirely determined by the arguments in the request that creates the certificate. So, Update requests are idempotent, which proves useful for tolerating compromised on-line CA servers.

Determining a Response for Query. On-line CA Update requests are processed by correct on-line CA servers in some quorum and not necessarily by all correct on-line CA servers. Consequently, a correct on-line CA server p can be ignorant of certificates having larger serial numbers than p stores for a name cid. If Query always returns a valid certificate, it implies that all completed Update requests (hence, all certificates) are taken into account in determining the response to a Query request Q. To satisfy this, a quorum of on-line CA servers must be engaged in processing Q. All on-line CA servers are contacted and responses from a quorum of on-line CA servers are expected. Each on-line CA server in a quorum Qm responds with the certificate (signed by the on-line CA) having the largest serial number among all certificates (for cid) known to the on-line CA server. The certificate ζ that has the largest serial number among the correctly signed certificates received in the responses from Qm is the response to Q.

This choice of ζ satisfies parts (i) and (ii) in the specification for Query. Part (i) stipulates that a certificate returned for Query is created by an accepted Update. This condition will be satisfied by ζ because a certificate is signed by the on-line CA only after the Update request creating that certificate has been accepted. The (n, t+1) threshold cryptography being employed for digital signatures requires cooperation (collusion) by more than t on-line CA servers in order to sign a certificate. Given the assumption of at most t compromised on-line CA servers, it is concluded that there are not enough compromised on-line CA servers to create bogus signed certificates. Therefore, when a certificate is signed, a correct on-line CA server must have participated in processing the request that created the certificate; the request creating the certificate had to have been accepted. The signature on certificates also prevents a compromised on-line CA server from submitting a bogus certificate with an arbitrarily high serial number during the processing of a Query request without being detected.

Part (ii) of the Query specification requires that, for any Update request U naming cid and completed before Q is accepted, σ(ζ′)≦σ(ζ) must hold where ζ′ is the certificate created by U. This holds for the implementation outlined above due to Quorum Intersection, because some correct on-line CA server p in Qm must also be in the quorum that processed U. Let certificate ζₚ be p's response for Q. Because p always chooses the certificate for cid with the largest serial number, σ(ζ′)≦σ(ζₚ) holds. Because ζ is the certificate that has the largest serial number among those from all on-line CA servers in Q, σ(ζₚ)≦σ(ζ) holds. Therefore, σ(ζ′)≦σ(ζ) holds.

The Role of Delegates. After making a request R, a client awaits notification that R has been processed. Every request is processed by all correct on-line CA servers in some quorum; the client must be notified once that has occurred. Direct notification by on-line CA servers in the quorum is not possible because clients do not know the public keys for on-line CA servers and, therefore, have no way to authenticate messages from those on-line CA servers. So, instead, an on-line CA server is employed to detect the completion of request processing and then to notify the client, as follows. A delegate for a request R is an on-line CA server that causes R to be processed by correct on-line CA servers in some quorum and then sends a response (signed by the on-line CA) back to the initiating client. The processing needed to construct the response depends on the type of request being processed.

To process a Query request Q for name cid, the delegate obtains certificates from a quorum of on-line CA servers, picks the certificate ζ having the largest serial number, and uses the threshold signature protocol to produce a signed response containing ζ:

1. Delegate forwards Q to all on-line CA servers.

2. Delegate awaits certificates for cid from a quorum of on-line CA servers.

3. Delegate picks the certificate ζ having the largest serial number of those received in step 2.

4. Delegate invokes the on-line CA's threshold signature protocol to sign a response containing ζ; that response is sent to the client.

To process an Update request U for name cid, the delegate constructs the certificate ζ for the given new binding (using the threshold signature protocol to have the on-line CA digitally sign it) and then sends ζ to all on-line CA servers. An on-line CA server p replaces the certificate ζ^{cid}ₚ: for cid that it stores by ζ if and only if the serial number ζ in is larger than the serial number in ζ^{cid}ₚ:

1. Delegate constructs a new certificate ζ for cid, using the threshold signature protocol to sign the certificate.

2. Delegate sends ζ to every on-line CA server.

3. Every on-line CA server, upon receipt, replaces the certificate for cid it had been storing if the serial number in ζ is larger. The on-line CA server then sends an acknowledgment to the delegate.

4. Delegate awaits these acknowledgments from a quorum of the on-line CA servers.

5. Delegate invokes the on-line CA's threshold signature protocol to sign a response; that response is sent to the client.

Quorum Availability ensures that a quorum of on-line CA servers are always available, so step 2 in Query and step 4 in Update are guaranteed to terminate. Since quorums contain 2t+1 on-line CA servers, compromised on-line CA servers cannot prevent a delegate from using (n, t+1) threshold cryptography in constructing the on-line CA signature for a certificate or a response. Thus, step 4 in Query and steps 1 and 5 in Update cannot be disrupted by compromised on-line CA servers.

A compromised delegate might not follow the protocol just outlined for processing Query and Update requests. The on-line CA ensures that such behavior does not disrupt the service by enlisting t+1 delegates (instead of just one) for each request. At least one of the t+1 delegates must be correct, and this delegate can be expected to follow the Query and Update protocols. So, it is stipulated that a (correct) client making a request to the on-line CA submits that request to t+1 on-line CA servers; each on-line CA server then serves as a delegate for processing that request. An optimization discussed below makes it possible for clients, in normal circumstances, to submit requests to only a single delegate.

With t+1 delegates, a client might receive multiple responses to each request and each request might be processed repeatedly by some on-line CA servers. The duplicate responses are not difficult for clients to deal with-a response is discarded if it is received by a client not waiting for a request to be processed. That each request might be processed repeatedly by some on-line CA servers is not a problem either, because the on-line CA's Query and Update implementations are idempotent.

A compromised client might not submit its request to t+1 delegates, as is now required. The on-line CA system must ensure that Request Completion is not violated. The problem occurs if the delegates receiving that request R execute the first step of Query or Update processing and then halt. Correct on-line CA servers now participate in the processing of R, so (by definition) R is accepted. Yet no (correct) delegate is responsible for R. Request R is never completed, and Request Completion is violated.

It must be ensured that some correct on-line CA server becomes a delegate for each request that has been received by any correct on-line CA server. The solution is straightforward:

Messages related to the processing of a client request R contain R.

Whenever an on-line CA server receives a message related to processing a client request R, that on-line CA server becomes a delegate for R if it is not already serving as one.

The existence of a correct delegate is now guaranteed for every request that is accepted.

Self-Verifying Messages. Compromised delegates could also attempt to produce an incorrect (but correctly signed) response to a client by sending erroneous messages to the on-line CA servers. For example, in processing a Query request, a compromised delegate might construct a response containing a bogus or invalidated certificate and try to get other on-line CA servers to sign that; in processing an Update request, a compromised delegate might create a fictitious binding and try to get other on-line CA servers to sign that; or when processing an Update request, a compromised delegate might not disseminate the updated binding to a quorum (causing the response to a later Query to contain an invalidated certificate).

The on-line CA's defense against erroneous messages from compromised on-line CA servers is a form of monitoring and detection called self-verifying messages. A self-verifying message comprises

information the sender intends to convey, an evidence enabling the receiver to verify-without trusting the sender-that the information being conveyed by the message is consistent with some given protocol and also is not a replay.

In the on-line CA, every message a delegate sends on behalf of a request contains a transcript of relevant messages previously sent and received in processing that request (including the original client request). A compromised delegate cannot forge the transcript because messages contained in the transcript are signed by their senders. The receiver of such a self-verifying message can independently establish whether messages sent by a delegate are consistent with the protocol and the messages received because the members of the quorum participating in the protocol are known to all. In the past, the notion of a fail-stop protocol has been introduced, which is a protocol that halts in response to certain attacks. One class of attacks is thus transformed into another, more benign, class. The self-verifying messages of the present invention can be seen as an-instance of this approach, transforming certain Byzantine failures to more-benign failures.

Returning to the erroneous message examples given above, here is how the self-verifying messages used in the on-line CA system prevent subversion of the service:

Compromised delegates cannot cause the on-line CA to sign a Query response containing a bogus or invalidated certificate, because messages instructing on-line CA servers to sign such a response must contain signed messages from a quorum of on-line CA servers, where these signed messages contain the certificates submitted by on-line CA servers for this Query.

Compromised delegates are prevented from creating a certificate that specifies a fictitious binding, because every message pertaining to an Update request must include the original client's signed request. The on-line CA servers check that message before signing a new certificate.

Compromised delegates that do not disseminate some new certificate to a quorum are foiled, because every subsequent message the delegate sends in processing this request must contain the signed responses from a quorum of on-line CA servers attesting that they received the new certificate.

Communicating using Fair Links. The Fair Links assumption means that not all messages sent are delivered. To implement reliable communication in this environment, a sender resends each message until a signed acknowledgment is received from the intended recipient. In turn, the recipient returns a signed acknowledgment for every message it receives (including duplicates, since the previous acknowledgments could have been lost). If both the sender and the receiver are correct then (due to Fair Links) this protocol ensures that the receiver eventually receives the message, the sender eventually receives an acknowledgment from the receiver, and the sender exits the protocol.

The protocols in the on-line CA are structured as a series of multicasts, with information piggybacked on the acknowledgments. A client starts by doing a multicast to t+1 delegates; the signed response from a single delegate can be considered the acknowledgment part of that multicast. A delegate then interacts with the on-line CA servers by performing multicasts and awaiting responses from on-line CA servers. For the threshold signature protocol, t+1 correct responses suffice; for retrieving and for updating certificates, responses from a quorum of on-line CA servers are needed. Thus, with at least 2t+1 correct on-line CA servers, the on-line CA servers' multicasts always terminate due to Quorum Availability since a delegate is now guaranteed to receive enough acknowledgments at every step and, therefore, eventually that delegate will stop retransmitting messages.

Defense Against Denial Of Service Attacks. A large class of successful denial of service attacks work by exploiting an imbalance between the resources an attacker must expend to submit a request and the resources the service must expend to satisfy that request. If making a request is cheap but processing one is not, then attackers have a cost-effective way to disrupt a service by submitting bogus requests to saturate server resources. A service, like the on-line CA, where request processing involves expensive cryptographic operations and multiple rounds of communication is especially susceptible to such resource clogging attacks.

The present on-line CA implements three classic defenses to blunt resource-clogging denial of service attacks:

1. An authorization mechanism identifies requests on which resources should not be expended;

2. Requests are grouped into classes, and resources are scheduled in a manner that prevents demands by one class from affecting requests-in another class; and

3. The results of expensive cryptographic operations are cached, and attackers cannot destroy the locality that makes this cache effective.

Note, that the present Fair Links and Asynchrony system-model assumptions are an important defense against denial of service attacks. An attacker stealing network bandwidth or cycles from processors that run the on-line CA servers is not violating assumptions needed for the on-line CA's algorithms to work. Such a “weak assumptions” defense is not without a price, however. Implementing real-time service guarantees on request processing requires a system model with stronger assumptions than those made in the present invention. Consequently, the on-line CA can guarantee only that requests it receives are processed eventually. Those who equate availability with real-time guarantees would not be satisfied by an eventuality guarantee.

Finally, the present on-line CA employs connectionless protocols for communication with clients and on-line CA servers, so the on-line CA is not susceptible to connection-depletion attacks such as the well-known TCP SYN flooding attack. The proactive secret sharing protocol in the current on-line CA implementation does use SSL (Secure Socket Layer) and is, therefore, subject to certain denial of service attacks. This vulnerability could be eliminated by restricting the rate of SSL connection requests, reprogramming the proactive secret sharing protocol, or adopting the mechanisms described by Juels and Brainard in the “Proceedings of the 1999 Network and Distributed System Security Symposium,” pages 151-165, San Diego, Calif. Feb. 4, 5, 1999.

Request-Processing Authorization. Each message received by an on-line CA server of this invention must be signed by the sender. The on-line CA server rejects messages that do not pass certain sanity checks, are not correctly signed, or are sent by clients or on-line CA servers that, from messages received in the past, were deemed by this on-line CA server to have been compromised.

An invalid self-verifying message, for example, causes the receiver r to judge the sender s compromised, and the request-processing authorization mechanism at r thereafter will reject messages signed by s (until instructed otherwise, perhaps because s has been repaired).

Verifying a signature is considerably cheaper than executing an Update or Query request (which involve threshold cryptography and multiple rounds of message exchange). Nevertheless, verifying a signature is not free, and an attacker might still attempt to flood the on-line CA with requests that are not correctly signed. Should this vulnerability ever become a concern, a still-cheaper authorization check can be added. The authorization check request must pass before signature verification is attempted. Cookies, hash chains, and puzzles are examples of such checks.

Of course, any server-based mechanism for authorization will consume some server resources and thus could itself become the target of a resource clogging attack, albeit an attack that is more expensive to launch by virtue of the additional authorization mechanism. An ultimate solution is authorization mechanisms that also establish the origin of the request being checked, since fear of discovery and reprisal is an effective deterrent.

Resource Management. The present on-line CA servers are able to identify the client and/or on-line CA server associated with each message received because requests are signed. This enables each on-line CA server to limit the impact that any compromised client or on-line CA server can have. In particular, each on-line CA server stores messages it receives in one of a set of input queues and employs some scheduler to service those queues. The queues and scheduler limit the fraction of an on-line CA server's cycles that can be co-opted by an attacker.

The on-line CA of this invention has a configurable number of input queues at each on-line CA server. A round-robin scheduler services these queues. Client requests are stored on one or more queues, and messages from the on-line CA server are stored on a separate queue associated with that on-line CA server. Duplicates of an element already present on a queue are never added to that queue. Each on-line CA server queue has sufficient capacity so replays of messages associated with a request currently being processed cannot cause the queue to overflow (since that would constitute a denial of service vulnerability).

In a production setting, a more sophisticated scheduler and a rich method for partitioning client requests across multiple queues are employed. Clients might be grouped into classes, with requests from clients in the same administrative domain stored together on a single queue.

Caching. Replays of legitimate requests are not rejected by the on-line CA's authorization mechanism. Nor should they be, since Fair Links forces clients to resend each request until enough acknowledgments are received. Attackers, however, now have an inexpensive way to generate requests that will pass the present on-line CA's authorization mechanism, and the on-line CA must somehow defend against such replay-based denial of service attacks.

There are two ways to redress an imbalance between the cost of making requests and the cost of satisfying them. One is to increase the cost of making a request, and that is what the signature checking in the on-line CA's authorization mechanism does. A second is to decrease the cost of processing a request. The on-line CA of this invention also embraces this latter alternative. Each on-line CA server caches responses to client requests and caches the results of expensive cryptographic operations for requests that are in progress. On-line CA servers use these cached responses instead of recalculating them when processing replays.

The cache for client responses is managed differently than the cache of in-progress cryptographic results. The following description deals with the client-response cache. Each on-line CA server cache has finite capacity, so all responses to clients cannot be cached indefinitely. If the on-line CA server cache is to be effective against replays submitted by clients, the chance of such replays causing cache misses (and concomitant costly computation by the on-line CA server) must be minimized. The solution is to ensure that client replays are forced to exhibit a temporal locality consistent with the information being cached. In particular, by caching the on-line CA's response for each client's most recent request, restricting clients to making one request at a time, and by having clients associate ascending sequence numbers with their requests, older requests not stored in the cache can be rejected as bogus by the on-line CA's authorization mechanism. For example, in a system with a million clients, this client cache would be roughly 5 gigabytes because approximately 5K bytes is needed to store a client's last request and the on-line CA's response.

A given on-line CA server's cache of client responses might n o t be current because requests are processed by a quorum of on-line CA servers-and not necessarily by all on-line CA servers. Thus, a replay request signed by client c to some on-line CA server s might have a sequence number that is larger than the sequence number for the last response cached at s for c. The larger sequence-numbered request would not be rejected by s and could not be satisfied from the cache-the request would have to be processed. With quorums comprising 2t+1 of the 3t+1 on-line CA servers, at most t such replays can lead to computation by the on-line CA servers. The on-line CA's implementation further limits susceptibility to these attacks. Whenever the on-line CA server sends a response to a client, that response is also sent to all other on-line CA servers. Each on-line CA server is thus quite likely to have cached the most recent response for every client request.

Clients are not the only source of replay-based denial of service attacks. Compromised on-line CA servers also could attempt such attacks. The on-line CA's defense here too is a cache. On-line CA servers cache results from all expensive operations, such as computing new shares for proactive secret sharing and computing partial signatures for in-progress requests. The cache at each on-line CA server is sufficiently large to handle the maximum number of requests that all on-line CA servers could have in-progress at any time. A total of 60K bytes suffices for a cache to support one client request, when, for example, X.509 certificates do not exceed 1024 bytes (which seems reasonable, given observed usage).

The on-line CA of the present invention limits the number of requests that can be in-progress at any time by having each delegate limit the number of requests it initiates. Of course, a compromised delegate would not respect such a bound. Recall that the on-line CA servers are notified when responses are sent, so an on-line CA server can estimate the number of concurrent requests that each on-line CA server (delegate) has in progress. The on-line CA servers can thus ignore messages from on-line CA servers that initiate too many concurrent requests.

Performance of the on-line CA. An example of an on-line CA prototype is approximately 35K lines of new C source; employing a threshold RSA scheme and a proactive threshold RSA scheme (using 1024-bit RSA keys) that was built using OpenSSL. Certificates stored on the on-line CA servers are in accordance with X.509, with the CA system's serial number embedded in the X.509 serial number.

Much of the cost and complexity of the on-line CA's protocols is concerned with tolerating failures and defending against attacks, even though failures and attacks are infrequent today. What is normally expected:

N1: On-line CA servers will satisfy stronger assumptions about execution speed.

N2: Messages sent will be delivered in a timely way.

The on-line CA prototype of this invention is optimized for these normal circumstances. Wherever possible, redundant processing is delayed until there is evidence that assumptions N1 and N2 no longer hold.

In particular, the present on-line CA prototype sequences when on-line CA servers start serving as delegates for client requests already in progress. This reduces the number of delegates when N1 and N2 hold, hence it reduces the cost of request processing in normal circumstances. The refinements to the protocols described above are:

A client sends its request only to a single delegate at first. If this delegate does not respond within some timeout period, then the client sends its request to another t delegates, as required by the above-described protocols.

An on-line CA server that receives a message in connection with processing some client request R and that is not already serving as a delegate for R does not become a delegate until some timeout period has elapsed.

A delegate p sends a response to all on-line CA servers, in addition to sending the response to the client initiating the request, after the request has been processed. After receiving such a response, an on-line CA server that is not a delegate for this request will not become one in the future; an on-line CA server that is serving as a delegate aborts that activity.

A cached response will be forwarded to an on-line CA server q whenever q instructs p to participate in the processing of a request that has already been processed. Upon receiving the forwarded response, q immediately terminates serving as a delegate for that request.

Also, the threshold signature protocol the on-line CA uses is designed to give better performance when N1 and N2 hold.

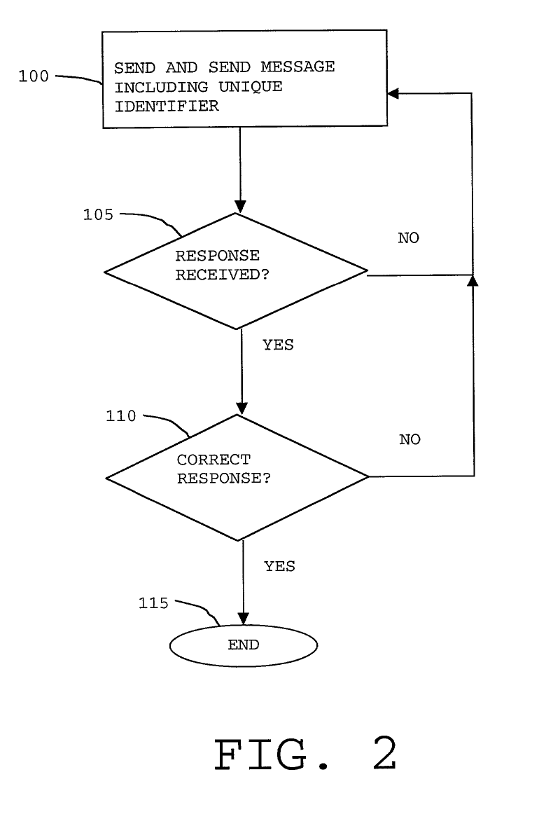

FIG. 2 is a flow chart of the client process in sending and receiving messages according to the present invention. The client digitally signs and sends a message, including a unique identifier, to t+1 on-line CA servers, block 100. The client continues to send these messages to these potential delegates until a response is received from one of the delegates, block 105. When a response is received from some delegate, the client determines if it is a correct response, block 110. That is, the client checks the digital signature of the response from the delegate using the public key of the service. If the digitally signed response contains the unique identifier initially sent by the client, then the message is a correct response from the delegate and the client stops sending messages, block 115. If the response is not correct, then the client continues to send messages, block 100.

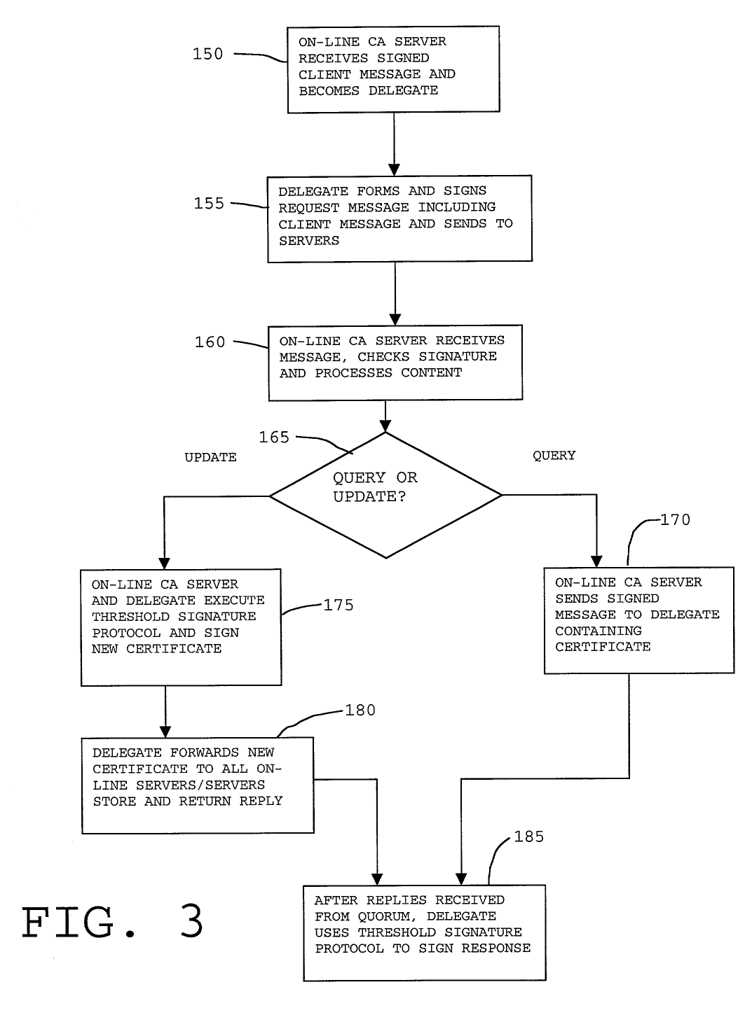

FIG. 3 is a flow chart of the server process according to principles of the invention. An on-line CA server receives a digitally signed message sent by a client and becomes a delegate for processing that message, block 150. The delegate includes the client message in a request message, which it digitally signs and forwards to all other on-line CA servers, block 155.

Upon receipt of such a request message, an on-line CA server checks the signature and performs processing based on the contents of that message, block 160. If the message contents specify a query operation, block 165, then the server sends a reply message to the delegate with a digitally signed message containing the certificate being sought by the original client message, block 170. If the message contents specify an update operation, then the server cooperates with the delegate to execute a threshold signature protocol and digitally sign the new certificate, block 175. In addition, for an update operation, once the threshold signature protocol has completed, the delegate forwards the signed new certificate to all on-line CA servers and, upon receipt, such a server stores this certificate and sends a reply message to the delegate, block 180.

Once the delegate has received replies for the query or update from a quorum of on-line CA servers, the delegate invokes the threshold signature protocol to digitally sign using the service private key a response to the original client message, and then the delegate sends that response to the client, block 185.

It is to be understood that the above-described embodiments are simply illustrative of the principles of the invention. Various and other modifications and changes may be made by those skilled in the art which will embody the principles of the invention and fall within the spirit and scope thereof.

### APPENDIX DESCRIBING PROTOCOLS

This appendix provides details for the protocols described in Detailed Description. The protocol is initiated by a delegate p. In practice, more than one delegate could initiate the protocol for the same given request because an on-line CA server p starts acting as a delegate when p first receives the request or when p receives any message related to the processing of the request. The optimizations outlined in the Detailed Description are not included in this presentation.

The following notational conventions are used throughout the appendix:

p, q: on-line CA servers

C: on-line CA client

<m>ₖ: message m signed by on-line CA using its service private key k

<m>ₚ: message m signed by an on-line CA server p using p's private key

<m>_{c}: message m signed by a client c using c's private key

PS (m, sₚ): a partial signature for a message m generated by an on-line CA server p using p's share sₚ

[h₁→h ₂: m]: message m is sent from host (an on-line CA server or a client) h₁ to host h₂

[∀q. p→q: m_{q}]: message m_{q} is sent from on-line CA server p to on-line CA server q for every on-line CA server q

Each message includes a type identifier to indicate the purpose of the message.

Client Protocol.

Every client request has the form:

<type, c, seq, parm, cred>_{c},

where “type” indicates the type of the request, “c” is the client issuing the request, “seq” is a unique sequence number for the request, “parm” are parameters related to the request, and “cred” is credentials that authorize the request.

Clients use the following protocol to communicate with the on-line CA.

1. To invoke Query for the certificate associated with name cid, client c composes a request:

R=<query, c, seq, cid, cred>_{c}

To invoke Update to establish a new binding of key with name cid based on a given certificate ζ′ for cid, client c composes a request:

R=<update, c, seq, ζ′, <cid, key>, cred>_{c}

2. Client c sends R to t+1 on-line CA servers. It periodically re-sends R until it receives a response to its request. For a Query, the response will have the form <R, ζ>ₖ, where ζ′is a certificate for cid. For an Update, the response will have the form <R, done>ₖ.

Threshold Signature Protocol.

The following describes threshold signature protocol threshold_sign(m, E), where m is the message to be signed and E is the evidence used in self-verifying messages to convince receivers to generate partial signatures for m. While this protocol is appropriate for schemes such as threshold RSA, the protocol might not be applicable to other threshold signature schemes, such as those based on discrete logarithms. Those schemes may require an agreed-upon random number in generating partial signatures. Such schemes can be implemented by adding a new first step, in which a delegate decides a random number based on suggestions from t+1 on-line CA servers (to ensure randomness) and notifies others of this random number, before on-line CA servers can generate partial signatures. Different evidence is used in the protocols for Query and Update.

1. On-line CA server p sends to each on-line CA server q a sign_request message with message m to be signed and evidence E.

[∀q. p→q: <sign_request, p, m, E>)ₚ] (i)

2. Each on-line CA server q, upon receiving a sign_request message (i), verifies evidence E with respect to m. If E is valid, then q generates a partial signature using its share s_{q} and sends the partial signature back to p.

[q→p: <sign_response, q, p, m, PS(m, s_{q})>_{q}]

3. On-line CA server p periodically repeats step 1 until it receives partial signatures from a quorum of on-line CA servers (which includes a partial signature from p itself). In fact, p can try to construct the signature as soon as it has received t+1 partial signatures. p has to wait for more partial signatures only if some partial signatures it received are incorrect. On-line CA server p then selects t+1 partial signatures to construct signature <m>ₖ. If the resulting signature is invalid (which would happen if compromised on-line CA servers submit erroneous partial signatures), then p tries another combination of t+1 signatures. In the worst case, p must try t+1 out of a total of 2t+1 combinations. The cost is insignificant when t is small. There are conventional robust threshold cryptography schemes that can reduce the cost using error correction codes. This process continues until the correct signature <m>ₖ is obtained.

Query processing protocol.

1. Upon receiving a request R=(query, c, seq, cid, cred)_{c} from a client c, on-line CA server p first checks whether R is valid based on the credentials cred provided. If it is valid then p sends a query_request message to all on-line CA servers:

[∀q. p→q: <query_request, p, R>ₚ] (ii)

2. Each on-line CA server q, upon receiving query request message (ii), checks the validity of the request. If the request is valid, then q fetches the current signed local certificate associated with name cid: ζ_{q}=<cid, σ(ζ_{q}), key_{q}>ₖ. On-line CA server q then sends back to p the following message:

[q→p: <query_response, q, p, R, ζ_{q}>_{q}]

3. On-line CA server p repeats step 1 until it receives the query response messages from a quorum of on-line CA servers (including p itself). p verifies that the certificates in these messages are correctly signed by the on-line CA. Let ζ=(cid, σ, key>ₖ be the certificate with the largest serial number in these query response messages. On-line CA server p invokes threshold_sign(m, E), where m is (R, ζ) and E is the query response messages collected from a quorum of on-line CA servers, thereby obtaining (R, ζ)ₖ.

4. On-line CA server p sends the following response to client c:

[p→c: (R, ζ)ₖ]. To implement the optimization described in the Detailed Description, p also forwards the response to all other on-line CA servers. Henceforth, these on-line CA servers do not need to act as a delegate for this request any more. The same is true for the last step of Update request processing.

Update processing protocol.

1. Upon receiving a request R=<update, c, seq. ζ′, <cid, key>, cred>_{c} from a client c, on-line CA server p first checks whether R is valid, based on the credentials cred provided. If it is valid then p computes serial number σ(ζ)=(v+1, h(R)) for new certificate ζ, where v is the version number of ζ′ and h is a public collision-free hash function, and invokes threshold_sign(m, E), where m is (cid, σ(ζ), key) and E is R, thereby obtaining ζ=<cid, σ(ζ), key>ₖ.

2. On-line CA server p then sends an update-request message to every on-line CA server q.

[∀q. p→q: <update_request, p, R, ζ>ₚ] (iii)

3. Each on-line CA server q, upon receiving an update_request message (iii), updates its certificate for cid with ζ if and only if σ(ζ_{q})<σ(ζ), where ζ_{q} is the certificate for cid stored by the on-line CA server. On-line CA server q then sends back to p the following message:

[q→p: (update_response, q, p, R, done>_{q}]

4. On-line CA server p repeats step 2 until it receives the update_response messages from a quorum of on-line CA servers. p then invokes threshold_sign(m, E), where m is (R, done) and E is the update_response messages collected from a quorum of on-line CA servers, thereby obtaining <R, done>ₖ.

5. On-line CA server p sends the following response to client c:

[p→c: <R, done>ₖ]

What is claimed is:

1. A process for operating multiple certification server processors in a network providing certification services to client processors in communication with said network comprising the steps of:
(a) receiving a request from a first of said client processors at a second of said certification server processors acting as a delegate;
(b) said delegate processing said client request and forwarding a corresponding server request to all certification server processors;
(c) upon receiving responses from a quorum of certification server processors, said delegate (1) constructing a response to said client; (2) invoking a threshold signature protocol to sign said client response; and (3) forwarding said signed client response to said first client processor.

2. The process of claim 1 wherein the processing of step (b) comprises the construction of an update request including a new certificate using said threshold signature protocol to sign said certificate.

3. The process of claim 1 wherein said server response include serially-numbered certificates and construction of said response to said client includes selection of the certificate with a highest serial number.
